(19) United States
(12) Patent Application Publication
(10) Pub. No.: US 2018/0039836 A1
(43) Pub. Date: Feb. 8, 2018

(54) SINGLE CALL-TO-CONNECT LIVE COMMUNICATION TERMINAL, METHOD AND TOOL

(71) Applicant: AINEMO INC, Beijing (CN)

(72) Inventor: Chenfeng SONG, Las Vegas, NV (US)

(21) Appl. No.: 15/316,449

(22) PCT Filed: Sep. 15, 2014
(86) PCT No.: PCT/CN2014/086574

§ 371 Date: Oct. 30, 2017

(30) Foreign Application Priority Data
Jun. 5, 2014 (CN) 201410247191.1

(51) Int. Cl. G06K 9/00; H04N 7/14; G10L 25/51; H04N 5/235

(52) U.S. Cl. CPC G06K 9/00711; H04N 5/2351; H04N 7/142; H04N 7/147; G10L 25/51; G06K 2009/00738

(57) ABSTRACT

The present invention discloses a real-time communication terminal, method and tool that can be connected by unilateral calls, wherein the real-time communication terminal receives a connection request from a trusted user; automatically initiates an IP communication with a trusted user in response to receiving a connection request from a trusted user and automatically issuing a response to the connection request; in the IP communication with the trusted user, the acquired video and audio are sent to the trusted user, and at least the audio from the trusted user is received. Compared with the prior art, the invention automatically enhances the communication experience between the trusted user and the monitored side by enhancing the communication experience of the trusted user by responding to the connection request of the trusted user automatically through the communication terminal that can be connected by unilateral calls.

This application claims the benefit of a Chinese patent application No. 201410247191.1 filed on Jun. 5, 2014, with the title “SINGLE CALL-TO-CONNECT LIVE COMMUNICATION TERMINAL, METHOD, AND TOOL,” the entire content of which is incorporated herein by reference.

### TECHNICAL FIELD

The present invention relates to a communication technology, and more particularly, to a real-time communication terminal, method and tool that can be connected by unilateral calls.

### BACKGROUND

In the prior art, there is a household video monitoring system. A video camera is installed in a house, a captured video signal is sent to the remote monitoring side (such as mobile phone users). A screen in the monitor side displays the captured video, to achieve remote monitoring. However, remote video monitoring is not a two-way communication. Although the monitoring side of the user can see the situation inside the house, but the family members cannot hear the user, and cannot interact with the user. Therefore, the user experience of prior art is poor.

### SUMMARY

One of the technical problems to be solved by the present invention is to enhance the real-time interaction between those who need to be taken care of and to be patronized at a fixed location, and those in other non-fixed places or on the move, thereby enhancing the communication experience. It corresponds to a prevailing communication model in real life, that is, there is a specific social relationship between the user and the location being visited and the person being visited, such as the elderly and the children, the parents and the children, unlike the communication between strangers, without such step of the identity confirmation.

According to an embodiment of an aspect of the present invention, there is provided a real-time communication terminal that can be connected by unilateral calls comprise a video capturing unit, an audio capturing unit, a speaker and a transceiver; video and audio signals captured by the video capturing unit and the audio capturing unit are transmitted through the transceiver, and audio signals received by the transceiver are output through the speaker, wherein after receiving a connection request from a trusted user, the transceiver automatically issues a response to the connection request, thereby automatically establishing IP communication with the trusted user. “Connected by unilateral calls” means that a two-way communication is automatically established after receiving a call.

According to an embodiment of the present invention, the transceiver, after automatically establishing an IP communication with a trusted user, transmits only the video and audio signals acquired by the capturing unit and the audio capturing unit to the trusted user; in response to the bidirectional communication request from the trusted user, the transceiver transmits and the video and audio signals to the trusted user, at the same time output the audio from the trusted user is output through the speaker.

According to an embodiment of the present invention, the transceiver, after automatically establishing the IP communication with the trusted user, send the video and audio signals acquired by the video capturing unit and the audio capturing unit, to the trusted user while the audio from the trusted user is output through the speaker.

According to an embodiment of the present invention, the real-time communication terminal that can be connected by unilateral calls further comprises a display, wherein after the transceiver establishes an IP communication with a trusted user, if a video signal is received by the transceiver, the video is displayed; and if the transceiver does not receive a video signal, an icon of the trusted user is displayed.

According to an embodiment of the present invention, the transceiver, in response to receiving a connection request from another trusted user after establishing an IP communication with a trusted user, the other trusted user issues a response via the server IP communication and issues a request to the trusted user for IP communication via the server.

According to one embodiment of the present invention, in the case where the transceiver simultaneously establishes IP communication with a plurality of trusted users, the display simultaneously displays videos or icons of a plurality of trusted users.

According to one embodiment of the present invention, in response to one or more videos or icons in the videos or icons of the plurality of trusted users are selected, the transceiver disconnecting the IP communication with the trusted user corresponding to the one or more selected videos or icons, or the speaker does not output the sound of the trusted users corresponding to the one or more videos or icons.

According to one embodiment of the present invention, in response to one of the videos or icons of the plurality of trusted users is selected, the videos or icons of the selected trusted users are displayed as enlarged main frame.

According to an embodiment of the present invention, in response to a person or a specific person is identified from the video and audio acquired by the video capturing unit and the audio capturing unit, the transceiver sends a notification to a trusted user.

According to an embodiment of the present invention, the person or the specific person is identified based on one or more of face recognition, height recognition, voice recognition and the wireless signal indicated by the mobile phone.

According to an embodiment of the present invention, in response to specific actions are identified from the video and the audio acquired by the video capturing unit and the audio capturing unit, the transceiver sends a notification to a trusted user.

According to an embodiment of the present invention, the specific actions are identified by pre-established the model of the scheduled actions, the actions matching with the established model is searched by searching the video and audio acquired by the video capturing unit and the audio capturing unit separately.

According to one embodiment of the present invention, the model is generated by self-learning.

According to an embodiment of the present invention, the real-time communication terminal that can be connected by unilateral calls further comprises a depth sensor, which specific actions are identified according to the video and audio acquired by the video capturing unit and the audio capturing unit as well as the depth detected by the depth sensor.

According to an embodiment of the present invention, in response to an abnormal condition is recognized in the video and the audio acquired from the video capturing unit and the audio capturing unit respectively, the transceiver sends a notification to a trusted user.

According to an embodiment of the present invention, said abnormal condition is identified by identifying one or more of the following: the video capturing unit collects the dramatic changes in the video; the amplitude of audio collected by the audio capturing unit is above a certain threshold; the audio collection unit collects a dramatic change in the audio; a predetermined event is recognized from the video and the audio acquired by the video capturing unit and the audio capturing unit respectively, wherein pre-established the model of the scheduled event, the event matching with the established model is searched by searching the video and audio acquired by the video capturing unit and the audio capturing unit separately to identify a predetermined event.

According to an embodiment of the present invention, the real-time communication terminal that can be connected by unilateral calls further comprises: a rotating means for rotating the video capturing unit.

According to an embodiment of the present invention, in response to the video and audio acquired by the video capturing unit and the audio capturing unit, if one of the following elements is identified in the audio, the rotation means causes the video capturing unit to rotate in the direction facing the identified elements: a person or a specific person; a specific action; an abnormal condition.

According to an embodiment of the present invention, the real-time communication terminal that can be connected by unilateral calls further comprising a light sensor for sensing a change in ambient light around the real-time communication terminal, wherein the brightness of the display is adjusted according to the sensed change of the light.

According to an embodiment of another aspect of the present invention, there is also provided A tool installed in a mobile terminal, comprising: a transmission unit configured to transmit a connection request for a specific communication terminal in response to the first trigger; a receiving unit configured to receive an automatic response from the specific communication terminal to automatically establish an IP communication with said specific communication terminal.

According to an embodiment of the present invention, after automatically establishing IP communication with the specific mobile terminal, the receiving unit accepts a video and an audio from the specific communication terminal, and said transmission unit does not transmitting the audio of the user to the specific communication terminal; in response to the second trigger, the receiving unit receives the audio and video transmission unit from the specific communication terminal and said transmission unit transmits the audio to the specific communication terminal.

According to an embodiment of the present invention, after receiving the IP communication with said specific mobile terminal, the receiving unit receives the audio and video from said specific communication terminal, and the transmitting unit transmits the audio to the specific communication terminal.

According to an embodiment of the present invention, the first trigger comprises any of the following: the mobile terminal is power on; the tool is activated when the mobile terminal is powered on; a specific action on the user interface when the mobile terminal is powered on; a specific voice is received by the mobile terminal when the mobile terminal is powered on; the brightness sensed by the mobile terminal is enhance when the mobile terminal is powered on.

According to an embodiment of the present invention, the second trigger comprises any of the following: a specific action on the user interface is performed when the tool is active; the specific voice is received when the tool is active.

According to an embodiment of the present invention, when the mobile terminal stores a plurality of connections for a plurality of communication terminals, in response to a user's selection, the transmitting unit is configured to transmit a connection request for connecting to a specific communication terminal selected by the user.

According to an embodiment of a further aspect of the present invention, there is also provided A real-time communication method that connecting by unilateral calls comprising: receiving a connection request from a trusted user; automatically initiates an IP communication with a trusted user in response to receiving a connection request from a trusted user and automatically issuing a response to the connection request; in the IP communication with the trusted user, the acquired video and audio are sent to the trusted user, and at least the audio from the trusted user is received.

According to an embodiment of the present invention, the real-time communication method that connecting by unilateral calls further comprising: sending a notification to a trusted user in response to identifying one of the following elements from the acquired video and audio: a person or a specific person; a specific action; and an abnormal condition.

According to an embodiment of the present invention, the real-time communication method that connecting by unilateral calls further comprising: in response to receiving a connection request from another trusted user after establishing an IP communication with a trusted user, sending a reply via the server IP communication to another trusted user and sending a request to the trusted user for IP communication via the server.

Compared with the prior art, the real-time communication terminal that can be connected by unilateral calls provided by one embodiment of the invention automatically sends a response to the connection request through the transceiver in response to the connection request from the trusted user, thereby automatically establishing an IP communication connection with the trusted user. Compared with the prior art, it is possible for the user at the communication terminal to provide real-time interaction with the user at the monitoring end to improve the user experience, not only the user at the monitoring end can view the scenario at the communication terminal at any time. The user at the real-time communication terminal can establish the IP communication without need to manually confirm the connection request, which avoid the situation that there is nobody nearby the real-time communication terminal or there is someone nearby the real-time communication terminal but cannot pick up a call, therefore, cannot perform real-time monitoring.

While the configuration of one embodiment of the present invention provides the possibility of simultaneous bi-directional interaction between the end user and the real-time communication terminal, sometimes the monitoring end user also has the desire to know who is monitoring at the real-time communication terminal. Therefore, the transceiver can automatically establish the IP communication with the trusted user, only the video and the audio captured by the video capturing unit and the audio capturing unit are sent to the trusted user. In response to a two-way communication request from trusted user, not only the video and audio captured by the video capturing unit and audio capturing unit are sent to the trusted user, but also at the same time the audio from the trusted user's output by the speaker. In this way, the monitoring end user can flexibly choose whether to let the person at the communication terminal know that they are monitoring and improving the flexibility of the user of the monitoring side.

Further, the real-time communication terminal that can be connected by unilateral calls provided by one embodiment of the present invention makes the information display mode and the format of the data transmission more flexible based on whether the video is received and the different information is displayed.

Moreover, the real-time communication terminal that can be connected by unilateral calls provided by one embodiment of the present invention uses end-to-end direct communication when communicating with a single trusted user, and communicates with the server for IP communication when communicating with a plurality of trusted users, which the flexible communication means enables the communication terminal that can be connected by unilateral calls to effectively avoid wasting the server resources when communicating with a single trusted user and enabling the communication terminal that can be connected by unilateral calls to communicate with a plurality of trusted users by forward data through the server, so as to transmit large amounts of data faster and more accurate.

In addition, the communication terminal that can be connected by unilateral calls provided by one embodiment of the present invention can display the video or icons of the plurality of trusted users simultaneously by the display in IP communication with the plurality of trusted users, thereby enhancing the user's visual experience.

Moreover, the real-time communication terminal that can be connected by unilateral calls provided by one embodiment of the present invention may disconnect the IP communication from one or more of the trusted users by the transceiver in the case of it has IP communication with a plurality of trusted users, such that the trusted user of the real-time communication terminal that can be connected by unilateral calls is free to select the opposite parties to communication; and the speaker of the real-time communication terminal that can be connected by unilateral calls can output or not output sound to one or more trusted users, thereby further enhancing the flexibility for video communication/voice communication/only picture communication with trusted user.

Also, in response to one of the video or icons of the plurality of trusted users is selected, the real-time communication terminal that can be connected by unilateral calls provided by one embodiment of the present invention may enlarge the video or icon of the selected trusted user in a main frame, thus highlighting selected trusted user in a main frame which communicating with real-time communication terminal that can be connected by unilateral calls, to further enhance the user's visual experience.

In addition, the real-time communication terminal that can be connected by unilateral calls provided by one embodiment of the present invention can send a notification to a trusted user when a person or a specific person is identified based on the video and audio acquired by the video capturing unit and the audio capturing unit, respectively. So that trusted users only need to monitor when someone or a specific person appeared in a specific environment, so as to avoid continuous monitoring.

Moreover, the real-time communication terminal that can be connected by unilateral calls provided by one embodiment of the present invention may identify a particular person based on one or more of the face recognition, the height recognition, the voice recognition, and the wireless signal emitted by the mobile phone. So that the sensitivity of the communication terminal to the surrounding situation can be effectively improved.

In addition, the real-time communication terminal that can be connected by unilateral calls provided by an embodiment of the present invention can identify a specific action or an abnormal condition based on the video and audio acquired by the video capturing unit and the audio capturing unit, respectively, and send a notification to the trusted user. So that trusted users only need to monitor when someone or a specific person appeared in a specific environment, so as to avoid continuous monitoring.

In addition, the communication terminal that can be connected by unilateral calls provided by one embodiment of the present invention can generate a model in advance by setting a model for a predetermined action, or by generating a model in a self-learning manner, and searching audio and video from the video capturing unit and the audio capturing unit for the action matching the established model. So specific actions are identified with more flexible, more intelligent, more accurate to better monitor the surrounding situation.

In addition, the communication terminal that can be connected by unilateral calls provided by one embodiment of the present invention performs the recognition of the depth of the surroundings by using the depth sensor, and is more accurate in recognizing the three-dimensional object and the person, the specific person, the action, and the like.

Moreover, the video capturing unit of the real-time communication terminal that can be connected by unilateral calls provided by one embodiment of the present invention is rotatable, and it is further possible to turn toward the identified element, and to capture video for the specific event, which is more intelligently and flexibly.

Further, since in one embodiment of the present invention, the display brightness of the display can be adjusted according to the change of the ambient light around, and the visual comfort can be improved.

Since the tool installed in the mobile terminal provided by one embodiment of the present invention transmits a connection request for a specific communication terminal and is configured to receive an automatic response from the specific communication terminal so as to automatically establish an IP communication with the specific mobile terminal, users can establish the IP communication with a real-time communication terminal and do not need manually confirm the connection request at the side of the real-time communication terminal. It is prevented from unable to perform monitoring due to nobody at the side of communication terminal.

In the embodiment of the present invention, after establishing the IP communication with the specific mobile terminal automatically, the receiving unit receives the audio and audio from the specific communication terminal, the transmission unit does not transmit the audio of the user. In respond to the second trigger, the audio signal is transmitted to the specific communication terminal while the receiving unit receives the audio and video from the specific communication terminal. So that if the monitoring user does not want the person at the communication terminal to know that he/she is monitoring, the second trigger is not carried out so that the user of the monitoring side can flexibly select if the person at the communication terminal knows that he/she is monitoring and improving the flexibility of the monitoring side.

In one embodiment of the present invention, the triggering may be any one of the activation of the mobile terminal, the activation of the tool in the powered state of the mobile terminal, the specific action on the user interface in the mobile terminal, a specific voice received in the power-on state of the mobile terminal, and the brightness sensed by the mobile terminal is enhance when the mobile terminal is powered on. It improves the flexibility that the mobile terminal is triggered.

In addition, in one embodiment of the present invention, the mobile terminal may store a connection for a plurality of communication terminals, allowing the user to select one of the communication terminals to communicate so that a mobile terminal can simultaneously bind a plurality of communication terminal that can be connected by unilateral calls, to enhance user convenience.

It will be understood by those of ordinary skill in the art that although the following detailed description will be made regarding the illustrated embodiments and the accompanying drawings, the invention is not limited to these embodiments. Rather, the scope of the invention is broadly and is intended to limit the scope of the invention by the claims appended hereto.

### BRIEF DESCRIPTION OF THE DRAWINGS

Other features, objects, and advantages of the present invention will become apparent by reading the following detailed description of the non-limiting embodiments regarding the following drawings:

FIG. 1 shows a schematic block diagram of a communication terminal that can be connected by unilateral calls according to one embodiment of the present invention;

FIG. 2(a) shows a schematic diagram of the communication terminal that can be connected by unilateral calls and a single user performing IP communication according to one embodiment of the present invention;

FIG. 2(b) shows a schematic diagram of the communication terminal that can be connected by unilateral calls and a plurality of users performing IP communication according to another embodiment of the present invention;

FIG. 3 shows an external left view of the communication terminal that can be connected by unilateral calls according to one embodiment of the present invention;

FIG. 4 shows a block diagram of a mobile terminal according to one embodiment of the present invention;

FIG. 5 shows a flow chart of a real-time communication method that connecting by unilateral calls according to still another embodiment of the present invention.

The same or similar reference numerals in the drawings refer to like or similar parts.

### DETAILED DESCRIPTION

The invention will now be described in further detail with reference to the accompanying drawings.

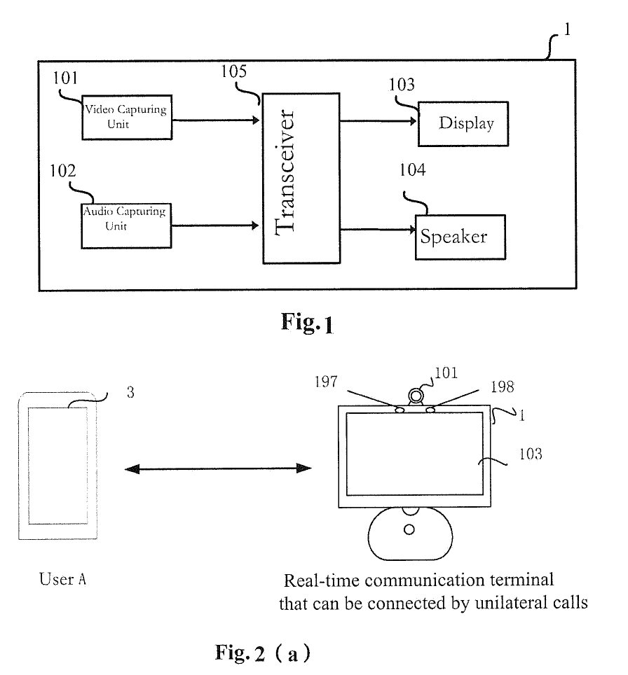

FIG. 1 shows a schematic diagram of a real-time communication terminal that can be connected by unilateral calls 1 according to one embodiment of the present invention. The real-time communication terminal that can be connected by unilateral calls 1 according to an embodiment of the present invention includes a video capturing unit 101, an audio capturing unit 102, a speaker 104, and a transceiver 105. The video and audio are collected by the video capturing unit 101 and the audio capturing unit 102, respectively, and the audio is transmitted through the transceiver 105. The audio received through the transceiver 105 is output through the speaker 104. The transceiver 101 automatically issues a response to the connection request in response to receiving a connection request from the user, thereby automatically establishing an IP communication with the user. “Connected by unilateral calls” means that a two-way communication is automatically established after receiving a call.

After the transceiver 101 automatically establishes the IP communication with the user, it is possible to automatically establish the two-way communication between the trusted user and the person at the communication terminal that can be connected by unilateral calls 1. That is, the audio from the trusted user is outputted through the speaker 104 while the video and the audio collected by the video capturing unit 101 and the audio collection unit 102 are transmitted to the trusted user. It is also possible to notify the trusted user only of the situation at the real-time communication terminal 1 without transmitting the audio or the like of the trusted user to the communication terminal that can be connected by unilateral calls 1 side. That is, only the video and audio acquired by the video capturing unit 101 and the audio capturing unit 102 are transmitted to the trusted user. When the trusted user sends a bidirectional communication request, the audio or the like of the trusted user is transmitted to the communication terminal that can be connected by unilateral calls 1 side, that is, the video and audio collected by the video capturing unit 101 and the audio capturing unit 102 are transmitted to the trusted user, and the audio from the trusted user is also output through the speaker 104.

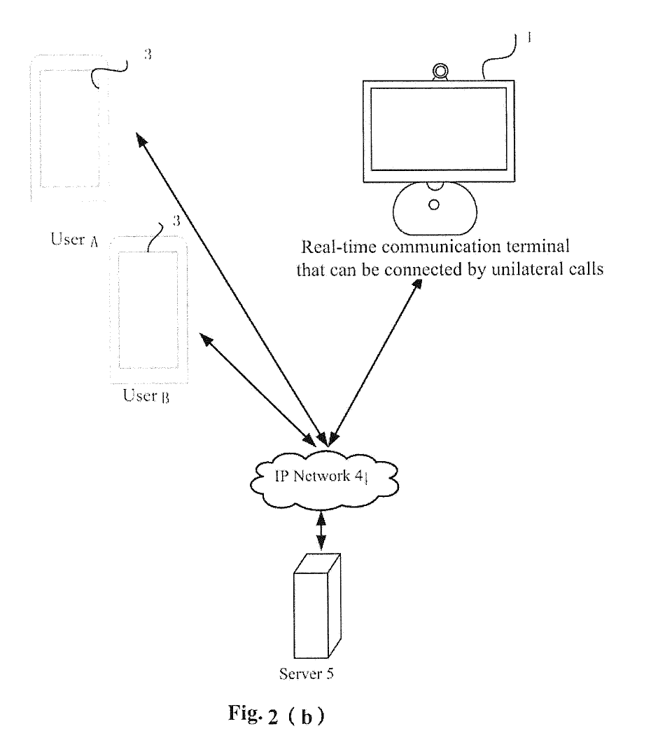

In FIG. 2, the video capturing unit 101 is a video camera at the upper end of the real-time communication terminal 1, but it will be understood by those skilled in the art that it may be other imaging devices located at other positions of the real-time communication terminal 1. The audio capturing unit 102 is, for example, a microphone of the outer surface of the real-time communication terminal 1, but may be another audio acquisition device. The speaker 104 is, for example, a player for the outer surface of the real-time communication terminal 1, but may also be other audio output devices. The transceiver 105 is, for example, an antenna, or other transceiver device, such as a built-in wireless transceiver module.

Herein, the communication terminal that can be connected by unilateral calls includes, but is not limited to, any electronic product that can interact with the user through a touch panel, a voice control device, a remote control device, or a keyboard, such as a computer, a tablet computer (PAD), Network television (IPTV), etc. It will be understood by those skilled in the art that other user equipment, if applicable to the present invention, should be included within the scope of the present invention.

The communication terminal that can be connected by unilateral calls 1 may further include a display 103 in which, after the transceiver 101 establishes communication with the IP of the trusted user, if the transceiver 105 receives video, then the display 103 displays the video; if the transceiver 105 does not receive the video, then the display displays a icon of the trusted user. Of course, the transceiver 103 may display only the icons of the trusted user even in the case where the video can be received. Wherein the icon of the trusted user may be a video footage, avatar, or other icon of a trusted user. Of course, the communication terminal that can be connected by unilateral calls 1 may not include the display 103, so that the real-time communication terminal 1 cannot see the image of the trusted user when communicating with the trusted user, and can only hear the voice of the trusted user.

FIG. 2(a) shows a schematic diagram of IP communication between a communication terminal that can be connected by unilateral calls 1 and a single trusted user according to one embodiment of the present invention. According to FIG. 2(a), IP communication is preferably performed based on a point-to-point protocol when the communication terminal 1 perform IP communication with the single trusted user to save the resources of the server. FIG. 2(b) shows a schematic diagram of IP communication between a communication terminal that can be connected by unilateral calls 1 1 and a plurality of trusted users according to another embodiment of the present invention. According to FIG. 2(b), when performing IP communication between the communication terminal that can be connected by unilateral calls 1 and the plurality of trusted users, the information is transmitted and received via the server 5 through the IP network 4.

Specifically, in the case of the trusted user A and the trusted user B, the IP communication is directly based on the point-to-point protocol when the real-time communication terminal that can be connected by unilateral calls 1 performs IP communication only with the trusted user A, when the communication terminal 1 has established an IP communication with the trusted user A and the connection request of the trusted user B is received, the communication terminal 1 sends a IP communication request via the server to the trusted user B and then sends a request to the trusted user A for IP communication via the server, after which both the trusted user A and the trusted user B communicate with the real-time communication terminal that can be connected by unilateral calls 1 through the server. The IP communication between the trusted user A and the real-time communication terminal that can be connected by unilateral calls 1 is switched from the point-to-point IP communication mode to the server for IP communication. Here, the server may include a network host, a single network server, a plurality of network server collections, or a cloud computing-based set of computers.

Optionally, in the case where the transceiver 105 of the real-time communication terminal that can be connected by unilateral calls 1 communicates with the plurality of trusted users at the same time, the display 103 of the real-time communication terminal that can be connected by unilateral calls 1 may simultaneously display a plurality of trusted user's video or icon. Preferably, in order to make the real-time communication terminal that can be connected by unilateral calls 1 more freely select the communication party, when one or more videos or icons in the video or icon of the plurality of trusted users is selected, the transceiver 105 of the communication terminal that can be connected by unilateral calls 1 disconnects the IP communication with the trusted user corresponding to the one or more videos or icons. Or the transceiver 105 does not output the selected one or more videos or icons of the corresponding trusted user's voice while still IP communicating with one or more trusted users, only the display 103 displays the selected one or more videos or identifying the video screen of the corresponding trusted user, and avoiding the interference of the voices of the plurality of trusted users heard by the person at the end of the real-time communication terminal.

Optionally, in order to better highlight the main picture in the display 103 of the real-time communication terminal 1, when one of the videos or icons of the plurality of trusted users is selected, the communication terminal that can be connected by unilateral calls 1, the video or icon of the selected trusted user is enlarged from the original screen to the large main picture.

According to an embodiment of the present invention, to more intelligently remind the trusted user of the case of a real-time communication terminal that can be connected by unilateral calls, in response to a person or a specific person is identified from the video and audio from the video capturing unit 101 and the audio capturing unit 102, the communication terminal that can be connected by unilateral calls 1 may sends a notification to the trusted user by the transceiver 105. Typically, when the communication terminal that can be connected by unilateral calls 1 is switched from an environment without any person presented to an environment with someone around, i.e., the video capturing unit 101 and the audio capturing unit 102 detects that a person is present in the current place, the transceiver 105 send a notification to the trusted user at the other end to inform the trusted user that there is someone presented in the current environment. Typically, the real-time communication terminal that can be connected by unilateral calls 1 may also actively send a notification to the trusted user by the transceiver 105 for the specific person identified by the video capturing unit 101 and the audio capturing unit 102. For example, in the real scenario, a nurse is at home, at that time a boy is returned from school, and the real-time communication terminal that can be connected by unilateral calls 1 at home identify the boy by the video capturing unit 101 and the audio capturing unit 102, and the transceiver 105 sends a notification in real-time to the remote user (such as the father in the office).

Optionally, the real-time communication terminal that can be connected by unilateral calls 1 may identify people or specific people by the video capturing unit 101, the audio capturing unit 102, and other devices or units, based on one or more of face recognition, height recognition, voice recognition, and wireless signals issued by the mobile phone.

In the case of identifying a person, because the pattern of the human face is very much like that of the vast majority of people, the person's voice frequency is within a certain range, so that, for example, when a certain area of a captured image is similar to the pattern of the stored face; and/or the distance between the face and the real-time communication terminal 1 sensed by the position sensor and/or the depth sensor indicate that the height of an object is within a certain range; and/or the voice acquired by the audio capturing unit 102 is also within a certain frequency range, the presence of a person is identified.

In the case of identifying a specific person, the pattern and/or the height and/or the voice frequency of the person's face of a specific person may be stored in the storage in advance. When a certain area in the captured image matches the stored pattern of the specific face; and/or the distance between the specific face and the real-time communication terminal that can be connected by unilateral calls 1 detected by the position sensor and/or the depth sensor indicate the height of the person matches with the height of a specific person stored in the storage; and/or the voice acquired by the audio capturing unit 102 matches the frequency of the stored specific person's voice, the specific person is identified.

The existence of a person or a specific person can also be done by self-learning. For example, if a pattern in the captured image always appears at the same time as a certain frequency of the acquired voice, a prompt can be displayed on the display, that is, the person is identified, and the user of the automatic monitoring and autonomous reaction device 1 shall confirm and named the identified person. If the user of the real-time communication terminal 1 indicates that the identified object is not correct, he shall give feedback on the interface of the display of the real-time communication terminal 1. When this feedback is received, the same captioned image occurring with the same frequency of captured voice is not considered as the present of a person or a specific person. In the self-learning mode, it is also possible to store the patterns of the specific person's face and/or the height and/or the voice frequency in the storage in advance.

In addition, it is also possible to identify people or specific people based on the wireless signals that are sent by the mobile phone. For example, the communication terminal that can be connected by unilateral calls 1 has a Bluetooth device, and the user's handset also has a Bluetooth wireless unit. It is considered that a specific person is identified when the communication terminal that can be connected by unilateral calls 1 recognizes that the Bluetooth wireless unit of a specific identity is presented in certain distance.

Herein, the means for identifying a person or a specific person for a communication terminal that can be connected by unilateral calls I is not limited, and any device or unit having an identifier or a specific person, if applicable, shall be included in the scope of protection of the present invention, and is hereby incorporated by reference herein.

Alternatively, the communication terminal that can be connected by unilateral calls 1 may also use the video capturing unit 101, which recognizes the specific action based on the acquired video and audio, for example, recognizing the action of the old man's fall, the action of the child dancing etc., and then the transceiver 105 send a notification to the trusted user at the other end.

Alternatively, the model may be set up manually and in accordance with the established action. When a specific action matching the one stored model is searched from the video and audio acquired by the video capturing unit 101 and the audio capturing unit 102, the notification is sent from the transceiver 105 to the trusted user at the other end. for an action to watch TV, create a model: identify a person sitting on the sofa; look along the direction of the person's eyes, there is an object; identify the object is the TV; the person's eyes stay on the TV at least 10 seconds. If the person is detected from the image taken from the video capturing unit 101 and then the person is seated on the sofa (the recognition of a sofa is similar to face recognition, it is also possible to perform the pattern matching, or taking the image of a person sitting on the sofa as a whole as a target for pattern matching recognition), and then detect the person's gaze direction, and then detect whether the object in the direction of the person's eyes is a TV (for example, the TV as an object to match the pattern), then countdowns 10 seconds. If it reaches 10 seconds, the action of watch TV is detected.

Of course, the real-time communication terminal that can be connected by unilateral calls 1 can automatically establish an action model by self-learning such as machine learning. For example, the real-time communication terminal that can be connected by unilateral calls 1 extracts an action feature from the video and audio acquired by the video capturing unit 101 and the audio collection unit 102, and creates an action model based on the extracted feature. For example, from the video and audio collected by the video capturing unit 101 and the audio collection unit 102, a person is identified as sitting on the couch, and there is a television in the direction of the person's eyes, where the person's eyes remain on the television at least ten second, which exceeds the threshold, then this is considered as a specific action model. In this case, the action model may be stored in the database without being stored in advance, but the model of the action is extracted in a learning manner from the video and the audio collected by the video capturing unit 100 and the audio capturing unit 102.

To more accurately identify a specific action, the real-time communication terminal that can be connected by unilateral calls 1 further comprises a depth sensor (197). A specific action is identified by the video and audio captured by video capturing unit 101 and the audio capturing unit 102, and the depth sensed by the depth sensor. The depth sensor measures the distance between a person or an object and a real-time communication terminal that can be connected by unilateral calls. Although as showed in FIG. 2(a), the depth sensor 197 may be located at a position other than the center of the upper frame of the display, and may be provided at other reasonable physical positions. When the person or object has an action, the same magnitude of motion varies depending on the distance from the communication terminal that can be connected by unilateral calls 1 in the captured image. Therefore, combined with the depth sensor, the action can be more accurate identification, thereby enhancing the recognition accuracy.

Optionally, the communication terminal that can be connected by unilateral calls 1 detects an abnormal condition from the video and audio collected by the video capturing unit 101 and the audio collection unit 102, and transmits the notification from the transceiver 105 to the trusted user at the other end. Among them, abnormal conditions such as visit by stranger, fire, crying, noisy, electrical accidents and so on. Typically, the anomaly is identified by identifying one or more of the following: the video capturing unit 101 collects the dramatic changes in the video; the amplitude of audio collected by the audio capturing unit 102 is above a certain threshold; the audio collection unit 102 collects a dramatic change in the audio; a predetermined event is recognized from the video and the audio acquired by the video capturing unit 101 and the audio capturing unit 102 respectively. Predetermined events are pre-defined events such as fire, electrical accidents and so on.

Specifically, the communication terminal that can be connected by unilateral calls 1 recognizes a predetermined event is recognized from the video and the audio acquired by the video capturing unit 101 and the audio capturing unit 102 respectively, wherein by searching the video and audio acquired by the video capturing unit 101 and the audio capturing unit 102 separately for the event matching with the established model to identify a predetermined event. Here, the communication terminal that can be connected by unilateral calls 1 can automatically establish a model of a predetermined event by self-learning such as machine learning. Typically, the real-time communication terminal that can be connected by unilateral calls 1 extracts event characteristics from the video and audio acquired by the video capturing unit 101, the audio collection unit 102, and establishes a model of a predetermined event based on the extracted event characteristics. Of course, in additional to using the self-learning method to establish a predetermined event model, the user may also specify a number of predetermined events model.

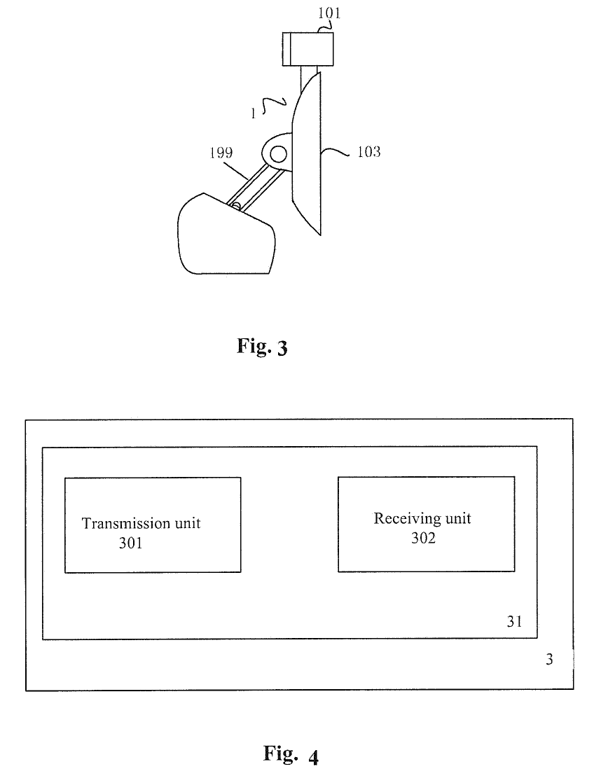

FIG. 3 shows an external left view of a real-time communication terminal that can be connected by unilateral calls according to one embodiment of the present invention. According to an embodiment of the present invention, in order to collect information better, the real-time communication terminal that can be connected by unilateral calls 1 further includes a turning device 199 for rotating the video capturing unit 101. As shown in figure. It is preferable that the rotation device 199 causes the video capturing unit 101 to rotate in the direction facing the identified element in response to one of the following elements identified in the audio and video acquired by the video capturing unit 101 and the audio collection unit 102: a person or a specific person; specific action; abnormal condition.

In one embodiment, the video capturing unit 101 shown in FIG. 3 may rotate left or right toward the identified element. In another embodiment, the video capturing unit 101 shown in FIG. 3 may be rotated up, down, left and right toward the identified elements.

As shown in FIG. 2(a), the communication terminal that can be connected by unilateral calls 1 may further include a light sensor 198 for sensing a change in ambient light around the real-time communication terminal 1, wherein the display brightness of the display 103 is adjusted according to the change of the light. If the surrounding light is strong, you can increase the display brightness of the display. If the surrounding light is weak, you can reduce the display brightness of the display. In this way, you can reduce the discomfort of the eyes to monitor the monitor.

Although the light sensor in FIG. 2(a) is located at the center of the center of the display, it can also be set at any other reasonable physical location.

It is to be understood that the block diagram shown in FIG. 1 is for illustrative purposes only and is not intended to limit the scope of the invention. In some cases, certain units or devices may be added or reduced depending on the circumstances.

It is to be noted that the above-mentioned communication terminal that can be connected by unilateral calls 1 transmits the notification to the trusted user based on the transceiver 105 by sending a message, such as a text message, a flying letter or a WeChat or a customized message under a private protocol, to the trusted user.

In this case, the trusted user at the other end communicates with the real-time communication terminal that can be connected by unilateral calls 1 in the wifi network environment, and of course, the trusted user at the other end can also communicate with each other through a network such as a 3G network, 2G network, 4G, and the like, and the communication terminal that can be connected by unilateral calls 1 is in communication with each other.

According to another embodiment of the present invention, as shown in FIG. 4, there is provided a tool 31 mounted on a mobile terminal 3 including a transmitting unit 301 and a receiving unit 302. As shown in Fig. The transmitting unit 301 is configured to transmit a connection request for a specific communication terminal (corresponding to the real-time communication terminal that can be connected by unilateral calls) in response to the first trigger. The receiving unit 302 is configured to receive an automatic response from the specific communication terminal so as to automatically establish an IP communication with the specific mobile terminal. The mobile terminal includes an electronic device such as a smartphone, a tablet computer, etc., which may be installed on a mobile terminal as an APP and displayed in the form of an application icon, which may also be implemented as a plug In the form of built-in mobile terminal. When the mobile terminal is in a network environment such as 2G or the like, the mobile terminal can transmit a notification to the mobile terminal when the mobile terminal is in a network environment such as 2G or so when the mobile terminal is in a network environment such as wifi or 3G or 4G.

After the automatic establishment of the IP communication with the specific mobile terminal, the transmitting unit 301 can transmit audio to the specific communication terminal while the receiving unit 302 receives video and audio from the specific communication terminal. After receiving the IP communication with the specific mobile terminal, the receiving unit 302 can receive the audio of the user from the specific communication terminal, and the transmission unit 301 does not transmit the audio of the user. In response to the second trigger, the receiving unit 302 receives the audio and video from the specific communication terminal, at the same time, the transmission unit 301 transmits audio to the specific communication terminal. In this way, if the user of the mobile terminal 3 does not want the person of the specific communication terminal to know that he is monitoring the specific communication terminal, the second trigger may not be performed, so that only the video and audio from the specific communication terminal are transmitted to the mobile terminal 3 The audio of the user of the mobile terminal 3 is not transmitted to the specific communication terminal.

The first trigger comprises any of the following: the activation of the mobile terminal; the activation of the tool in the mobile terminal; a specific action on the user interface when the mobile terminal is powered on; the mobile terminal is powered on, and the light is sensed by the mobile terminal.

When the first trigger is the start-up of the mobile terminal, the communication connection to the real-time communication terminal 1 is automatically performed as the mobile terminal is turned on. This allows the phone to automatically enter the system after the start of a real-time communication terminal that can be connected by unilateral calls 1 in the environment monitoring status, improve user efficiency.

In the case where the first trigger is the activation of the tool in the power-on state of the mobile terminal, the specific action on the user interface in the mobile terminal is turned on, or the specific voice is received by the mobile terminal. It is possible to decide whether or not to enter the monitoring state of the environment in which the real-time communication terminal 1 is located, and to increase the user's flexibility. Specific actions such as sliding, clicking, double clicking, etc., or entering specific content at a specific location on the touch screen.

In the case where the first trigger is the light is sensed by the mobile terminal, when the user takes out the mobile terminal from his pocket, the light is sensed and the brightness is increased, then automatically connecting with the real-time communication terminal that can be connected by unilateral calls 1. Therefore, it is avoided that the resource waste due to the connection resource of the real-time communication terminal that can be connected by unilateral calls 1 is still holded when the user does not wish to monitor the environment in which the real-time communication terminal 1 is located and the mobile terminal is placed in the pocket. In this manner, a light sensor is provided in the mobile terminal or tool for sensing the change of light on the surface of the mobile terminal.

The second trigger may include any of the following: a specific action on the user interface in the active state of the tool; and a specific voice received in the active state of the tool. A specific action can be a position on the user interface (such as sliding, click, double click, etc.) and so on. For example, the first trigger may be an action on a first icon on the user interface, and the second trigger is an action on a second icon that is different from the first icon on the user interface, and so on.

Alternatively, the transmission unit 301 is configured to transmit a connection request for a specific communication terminal selected by the user in response to a user input selection when the mobile terminal stores a connection for a plurality of communication terminals. For example, a list of a plurality of communication terminals may be displayed to a user for selecting. In response to this selection, a connection request is sent to the selected specific communication terminal.

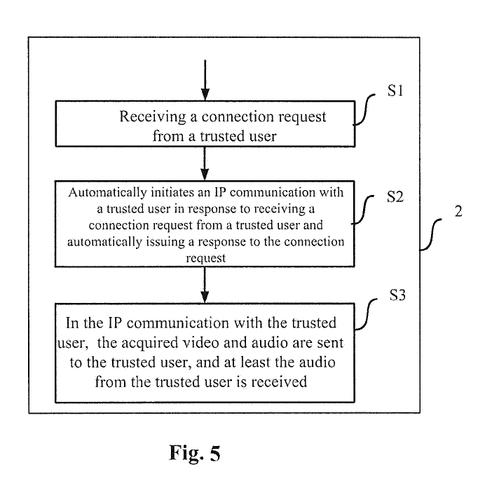

FIG. 5 shows a flow chart of a method of real-time communication that can be connected by unilateral calls 2 according to still another embodiment of the present invention. According to FIG. 5, the method of real-time communication that can be connected by unilateral calls 2 comprises:

Step S1, the real-time communication terminal that can be connected by unilateral calls receives the connection request from the trusted user;

Step S2 automatically initiates an IP communication with a trusted user in response to receiving a connection request from a trusted user and automatically issuing a response to the connection request;

In step S3, in the IP communication with the trusted user, the acquired video and audio are sent to the trusted user and at least the audio from the trusted user is received.

Further, the real-time communication method that connecting by unilateral calls further comprises: sending a notification to a trusted user in response to identifying one of the following elements from the acquired video and audio: a person or a specific person; a specific action; an abnormality situation.

Further, the method of real-time communication that can be connected by unilateral calls further comprises, in response to receiving a connection request from another trusted user after establishing an IP communication with a trusted user, sending to the other trusted user a response for IP communication via a server, and sends a request to the trusted user for IP communication via the server.

It will be appreciated by those skilled in the art that the present invention may be implemented as a device, device, method, or computer program product. Thus, the present disclosure may be embodied in the form of complete hardware, it may be complete software, and may be a combination of hardware and software.

The flowcharts and block diagrams in the figures show the architecture, functions, and operations of the systems, methods, and computer program products that may be implemented in accordance with various embodiments of the present invention. In this regard, each of the blocks in the flowchart or block diagram may represent a module, block, or part of a code that contains one or more portions of the module, block, or code for implementing the prescribed logic functions Executable instructions. It should also be noted that in some implementations as a replacement, the functions marked in the box may also occur in a different order than that noted in the figures. For example, two consecutive blocks can actually be executed substantially in parallel, and they can sometimes be executed in the reverse order, depending on the function involved. It should also be noted that each block in the block diagram and/or flowchart, as well as the combination of blocks in the block diagram and/or flowchart, may be implemented with a dedicated hardware-based system that performs a specified function or operation, Or can be implemented with a combination of dedicated hardware and computer instructions.

It will be apparent to those skilled in the art that the present invention is not limited to the details of the above-described exemplary embodiments and that the invention may be practiced in other specific forms without departing from the spirit or essential characteristics thereof. Accordingly, the scope of the invention should be considered by way of example only and not by way of limitation, and the scope of the invention is defined by the appended claims rather than by the foregoing description, and is therefore intended to be carried out with respect to the claims And all changes which come within the scope of the present invention are intended to be included within the scope of the present invention. Any reference signs in the claims should not be construed as limiting the claimed claims.

1. A real-time communication terminal that can be connected by unilateral calls, comprising:
a video capturing unit, an audio capturing unit, a speaker and a transceiver; video and audio signals captured by the video capturing unit and the audio capturing unit are transmitted through the transceiver, and audio signals received by the transceiver are output through the speaker, wherein
after receiving a connection request from a trusted user, the transceiver automatically issues a response to the connection request, thereby automatically establishing IP communication with the trusted user.

2. The real-time communication terminal according to claim 1, wherein the transceiver, after automatically establishing an IP communication with a trusted user, transmits only the video and audio signals acquired by the capturing unit and the audio capturing unit to the trusted user; in response to the bidirectional communication request from the trusted user, the transceiver transmits and the video and audio signals to the trusted user, at the same time output the audio from the trusted user is output through the speaker.

3. The real-time communication terminal according to claim 1, wherein the transceiver, after automatically establishing the IP communication with the trusted user, send the video and audio signals acquired by the video capturing unit and the audio capturing unit, to the trusted user while the audio from the trusted user is output through the speaker.

4. The real-time communication terminal according to claim 1, further comprising a display, wherein after the transceiver establishes an IP communication with a trusted user, if a video signal is received by the transceiver, the video is displayed; and if the transceiver does not receive a video signal, an icon of the trusted user is displayed.

5. The real-time communication terminal according to claim 4, wherein the transceiver, in response to receiving a connection request from another trusted user after establishing an IP communication with a trusted user, the other trusted user issues a response via the server IP communication and issues a request to the trusted user for IP communication via the server.

6. The real-time communication terminal according to claim 5, wherein in the case where the transceiver simultaneously establishes IP communication with a plurality of trusted users, the display simultaneously displays videos or icons of a plurality of trusted users.

7. The real-time communication terminal according to claim 5, wherein in response to one or more videos or icons in the videos or icons of the plurality of trusted users are selected, the transceiver disconnecting the IP communication with the trusted user corresponding to the one or more selected videos or icons, or the speaker does not output the sound of the trusted users corresponding to the one or more videos or icons.

8. The real-time communication terminal according to claim 5, wherein in response to one of the videos or icons of the plurality of trusted users is selected, the videos or icons of the selected trusted users are displayed as enlarged main frame.

9. The real-time communication terminal according to claim 1, wherein in response to a person or a specific person is identified from the video and audio acquired by the video capturing unit and the audio capturing unit, the transceiver sends a notification to a trusted user.

10. The real-time communication terminal according to claim 9, wherein the person or the specific person is identified based on one or more of face recognition, height recognition, and voice recognition.

11. The real-time communication terminal according to claim 9, wherein the transceiver further receives a wireless signal from the mobile phone, and identifies the person or the specific person based on the identity of the mobile phone indicated in the wireless signal.

12. The real-time communication terminal according to claim 1, wherein in response to specific actions are identified from the video and the audio acquired by the video capturing unit and the audio capturing unit, the transceiver sends a notification to a trusted user.

13. The real-time communication terminal according to claim 12, further comprising a depth sensor, which specific actions are identified according to the video and audio acquired by the video capturing unit and the audio capturing unit as well as the depth detected by the depth sensor.

14. The real-time communication terminal according to claim 1, wherein in response to an abnormal condition is recognized in the video and the audio acquired from the video capturing unit and the audio capturing unit respectively, the transceiver sends a notification to a trusted user.

15. The real-time communication terminal according to claim 14, wherein said abnoinial condition is identified by identifying one or more of the following:
the video capturing unit collects the dramatic changes in the video;
the amplitude of audio collected by the audio capturing unit is above a certain threshold;
the audio collection unit collects a dramatic change in the audio;
a predetermined event is recognized from the video and the audio acquired by the video capturing unit and the audio capturing unit respectively, wherein pre-established the model of the scheduled event, the event matching with the established model is searched by searching the video and audio acquired by the video capturing unit and the audio capturing unit separately to identify a predetermined event.

16. The real-time communication terminal according to claim 1, further comprising: a rotation means for rotating the video capturing unit.

17. The real-time communication terminal according to claim 16, wherein, in response to the video and audio acquired by the video capturing unit and the audio capturing unit, if one of the following elements is identified in the audio, the rotation means causes the video capturing unit to rotate in the direction facing the identified elements:
a person or a specific person;
a specific action;
an abnormal condition.

18. The real-time communication terminal according to claim 4, further comprising a light sensor for sensing a change in ambient light around the real-time communication terminal, wherein the brightness of the display is adjusted according to the sensed change of the light.

19. A tool installed in a mobile terminal, comprising:
a transmission unit configured to transmit a connection request for a specific communication terminal in response to the first trigger; and
a receiving unit configured to receive an automatic response from the specific communication terminal to automatically establish an IP communication with said specific communication terminal.

20. The tool according to claim 19, wherein after automatically establishing IP communication with the specific mobile terminal, the receiving unit accepts a video and an audio from the specific communication terminal, and said transmission unit does not transmitting the audio of the user to the specific communication terminal; in response to the second trigger, the receiving unit receives the audio and video transmission unit from the specific communication terminal and said transmission unit transmits the audio to the specific communication terminal.

21. The tool according to claim 19, wherein after receiving the IP communication with said specific mobile terminal, the receiving unit receives the audio and video from said specific communication terminal, and the transmitting unit transmits the audio to the specific communication terminal.

22. The tool according to claim 19, wherein the first trigger comprises any of the following:
the mobile terminal is power on;
the tool is activated when the mobile teiiiiinal is powered on;
a specific action on the user interface when the mobile terminal is powered on;
a specific voice is received by the mobile terminal when the mobile terminal is powered on; and
the brightness sensed by the mobile terminal is enhance when the mobile terminal is powered on.

23. The tool according to claim 20, wherein the second trigger comprises any of the following:
a specific action on the user interface is performed when the tool is active; and
the specific voice is received when the tool is active.

24. The tool according to claim 19, wherein when the mobile terminal stores a plurality of connections for a plurality of communication terminals, in response to a user's selection, the transmitting unit is configured to transmit a connection request for connecting to a specific communication terminal selected by the user.

25. A real-time communication method that connecting by unilateral calls comprising:
receiving a connection request from a trusted user (S1);
automatically initiates an IP communication with a trusted user in response to receiving a connection request from a trusted user and automatically issuing a response to the connection request (S2); and
in the IP communication with the trusted user, the acquired video and audio are sent to the trusted user, and at least the audio from the trusted user is received (S3).

26. The real-time communication method according to claim 25, further comprising: sending a notification to a trusted user in response to identifying one of the following elements from the acquired video and audio:
a person or a specific person;
a specific action; and
an abnormal condition.

27. The real-time communication method according to claim 25, further comprising: in response to receiving a connection request from another trusted user after establishing an IP communication with a trusted user, sending a reply via the server IP communication to another trusted user and sending a request to the trusted user for IP communication via the server.
